(19) United States
(12) Patent Application Publication
(10) Pub. No.: US 2004/0038097 A1
(43) Pub. Date: Feb. 26, 2004

(54) Fuel cell assembly and thermal environment control method

(75) Inventor: Ronald Scott Bunker, Niskayuna, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(73) Assignee: General Electric Company, Niskayuna, NY (US)

(21) Appl. No.: 10/064,808

(22) Filed: Aug. 20, 2002

(51) Int. Cl. H01M 8/04; H01M 8/12; H01M 8/02

(52) U.S. Cl. 429/22; 429/38; 429/24; 429/32; 429/30; 429/31; 429/13

(57) ABSTRACT

A fuel cell assembly (“Assembly”) includes a housing having an inlet and an outlet and defining at least one bypass flow channel, which is in fluid communication with the inlet. The inlet and outlet are configured to provide fluid communication to and from the housing, respectively. The Assembly further includes at least one fuel cell stack (“Stack”) that is disposed within the housing and includes at least one fuel cell. The Stack defines at least one direct flow channel, which is in fluid communication with the inlet and outlet. The Assembly further includes a control system, which is configured to control an oxidant flow from the inlet to the direct and bypass flow channels. A method for controlling a thermal environment of the Stack includes apportioning an oxidant flow between the direct and bypass flow channels.

### BACKGROUND OF INVENTION

The present invention relates generally to power generation equipment, such as fuel cells, and, more particularly, to thermal management of fuel cells, such as solid oxide fuel cells.

A fuel cell is an energy conversion device that produces electricity, by electrochemically combining a fuel and an oxidant across an ionic conducting layer. One typical construction of a high temperature fuel cell bundle is an array of axially elongated tubular shaped connected fuel cells and associated fuel and air distribution equipment. Other fuel cell constructions include planar fuel cells comprising flat single members. Exemplary planar fuel cells include counter-flow, cross-flow and parallel flow varieties. The members of a typical planar fuel cell comprise tri-layer anode/electrolyte/cathode components that conduct current from cell to cell and provide channels for gas flow into a cubic structure or stack.

In a solid oxide fuel cell, the oxygen ion transport (O²⁻) across the electrolyte produces a flow of electrons in an external load. The waste heat generated in a solid oxide fuel cell at its operating temperature of about 600° C. to about 1300° C. is typically removed via an oxidant in a flow channel to maintain a desired temperature level of the fuel cell components, such as the anode, cathode and electrolyte.

Fuel cell stacks, such as solid oxide fuel cell stacks, have demonstrated a potential for high efficiency and low pollution in power generation. However, problems associated with thermal management persist, particularly as regards optimization of the thermal performance of fuel cell stacks. Removal or internal use of the thermal energy generated in a fuel cell stack from the reaction of the fuel and oxidant is necessary both to maintain the operating temperature within prescribed limits and to maintain a desired thermal gradient across the fuel cell stack. Presently, cooling channels use air to cool planar fuel cells, by heat transfer or removal. Similarly, cooling tubes are used to cool tubular fuel cells. Both the cooling channels and tubes are designed to meet specific cooling requirements. However, cooling requirements change with the thermal load on the fuel cell stack, which in turn changes with the power output demand across the distribution network. Accordingly there is a need in the art to have a controlled and adjustable cooling mechanism, which can follow the thermal response of the stack to changing power output demand.

### SUMMARY OF INVENTION

Briefly, in accordance with one embodiment of the present invention, a fuel cell assembly is disclosed. The fuel cell assembly includes a housing having an inlet and an outlet and defining at least one bypass flow channel. The bypass flow channel is configured to be in fluid communication with the inlet. The inlet and the outlet are configured to provide fluid communication to and from the housing, respectively. The fuel cell assembly further includes at least one fuel cell stack that is disposed within the housing and includes at least one fuel cell. The fuel cell stack defines at least one direct flow channel, which is configured to be in fluid communication with the inlet and outlet. The fuel cell assembly further includes a control system, which is configured to control an oxidant flow from the inlet to the direct and bypass flow channels.

A method embodiment, for controlling a thermal environment of the fuel cell stack, is also disclosed. The method includes apportioning an oxidant flow between the direct and bypass flow channels.

### BRIEF DESCRIPTION OF DRAWINGS

These and other features, aspects, and advantages of the present invention will become better understood with reference to the following description, appended claims, and accompanying drawings.

FIG. 1 is an exploded view of a fuel cell in an exemplary internally manifolded fuel cell stack;

FIG. 2 is an exploded view of a fuel cell in an exemplary externally manifolded fuel cell stack;

FIG. 3 is a cross-sectional view of a fuel cell assembly embodiment of the invention;

FIG. 4 schematically depicts an exemplary control system of the fuel cell assembly of FIG. 3;

FIG. 5 is a cross-sectional view of another fuel cell assembly embodiment of the invention;

FIG. 6 is a cross-sectional view of yet another fuel cell assembly embodiment of the invention;

FIG. 7 shows the fuel cell assembly of FIGS. 3, 5, or 6 connected to other fuel cell assemblies;

FIG. 8 shows the fuel cell assembly of FIGS. 3, 5, or 6 exhausting to a gas turbine, for co-generation applications;

FIG. 9 shows the fuel cell assembly of FIGS. 3, 5, or 6 coupled to a gas turbine at an inlet of the fuel cell assembly;

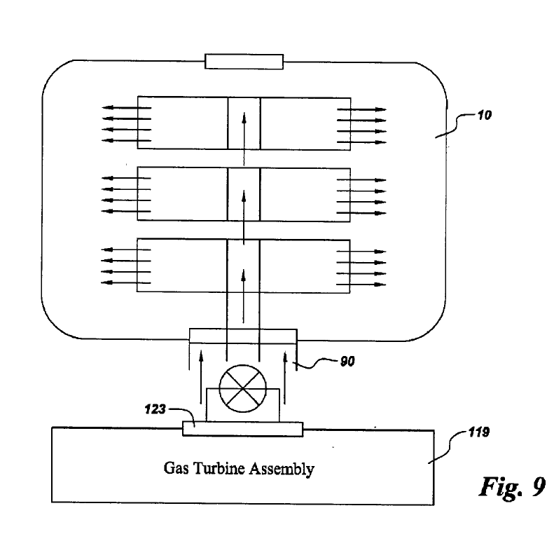

FIG. 10 is a cross-sectional view of a fuel cell assembly with bypass flow recycling;

FIG. 11 is an exploded view of an exemplary fuel cell having a tubular configuration; and

FIG. 12 is a cross-sectional view of another fuel cell assembly embodiment of the invention.

### DETAILED DESCRIPTION

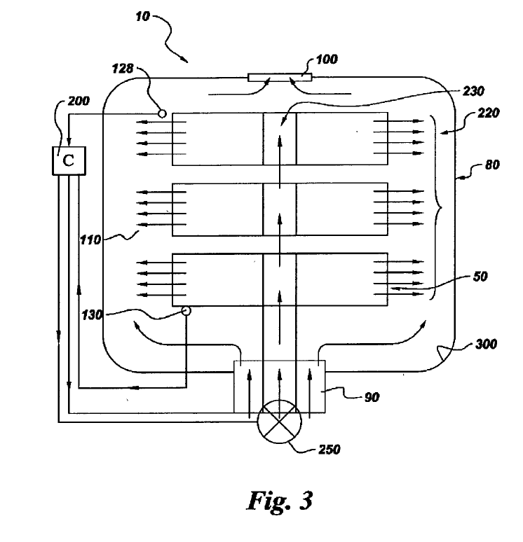

A fuel cell assembly 10 embodiment of the invention is described with reference to FIG. 3. As shown in FIG. 3, fuel cell assembly 10 includes a housing 80 having an inlet 90 and an outlet 100. Fuel cell assembly 10 further includes at least one fuel cell stack 220 disposed within housing 80 and a control system 92. Housing 80 defines at least one bypass flow channel 110, which is configured to be in fluid communication with inlet 90. Inlet 90 and outlet 100 are configured to provide fluid communication to and from housing 80 respectively, as indicated in FIG. 3. For the particular embodiment illustrated in FIG. 3, bypass flow channel 110 is also configured to be in fluid communication with outlet 100. Fuel cell stack 220 defines at least one direct flow channel 230, which is configured to be in fluid communication with inlet 90 and outlet 100. As indicated in FIG. 3, fuel cell stack 220 includes at least one fuel cell SO. Control system 92 is configured to control an oxidant flow from inlet 90 to direct and bypass channels 230, 110. One exemplary oxidant is air.

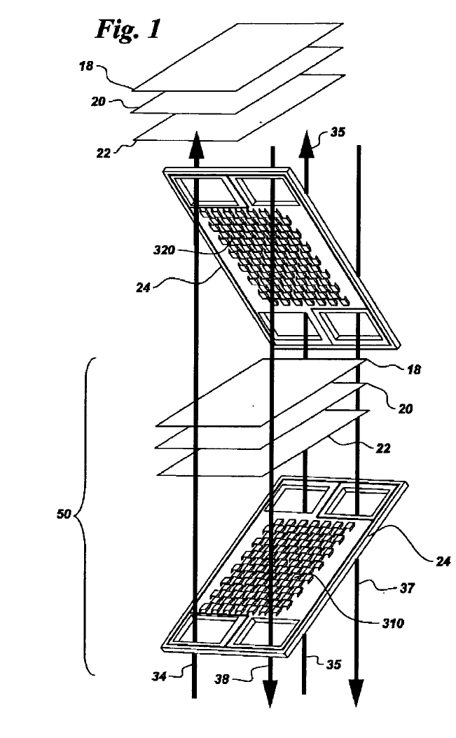

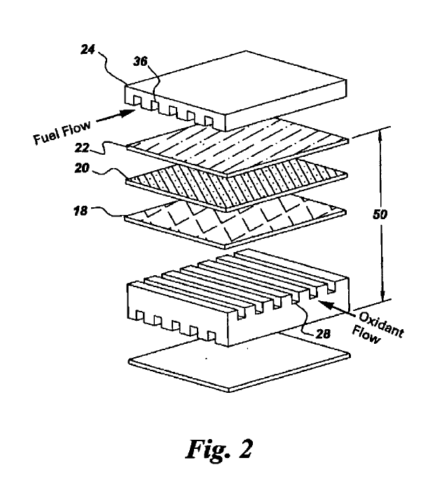

Fuel cells 50 are known and hence are not described in detail herein. However, by way of background, exemplary fuel cells 50 are shown in exploded view in FIGS. 1 and 2. Generally, fuel cells 50 are repeat cell units capable of being stacked together either in series and/or in parallel to construct a fuel cell stack system or architecture, capable of producing a resultant electrical energy output. Referring to FIGS. 1 and 2, an exemplary fuel cell 50 includes an anode 22, a cathode 18, and an electrolyte 20 interposed therebetween. According to a particular embodiment, fuel cell 50 is a solid oxide fuel cell (SOFC). For this embodiment, housing 80 is a pressure vessel 80. Other exemplary types of fuel cells 50 include proton exchange membrane or solid polymer fuel cells, molten carbonate fuel cells, phosphoric acid fuel cells, alkaline fuel cells, direct methanol fuel cells, regenerative fuel cells, zinc air fuel cells and protonic ceramic fuel cells.

Fuel cell stack 220 includes at least one fuel cell 50, as noted above, and according to one embodiment, fuel cell stack 220 includes a number of planar fuel cells for example solid oxide fuel cell 50 arranged in a stack such as vertical stack, as indicated in an exemplary arrangement in FIG. 3. Electrical connections between fuel cells 50 are made via interconnects 24, each of which is in intimate contact with at least one of anode 22, cathode 18 and electrolyte 20. Fuel cell stack 220 further includes at least one fuel flow area 315 and at least one oxidant flow area 320. For the exemplary fuel cell stack 220 shown in part in FIG. 2, fuel flow area 315 includes a number of fuel flow channels 36, and oxidant flow area 320 includes a number of oxidant flow channels 28. The exemplary fuel cell stack 220 shown in part in FIG. 1 further includes at least one fuel flow manifold 34, at least one fuel exhaust manifold 37, at least one oxidant flow manifold 35 and at least one oxidant exhaust manifold 38. The exemplary fuel cell stacks 220 further include a top end plate (not shown) disposed above an uppermost fuel cell 50 and a bottom end plate (not shown) disposed below a lower fuel cell 50.

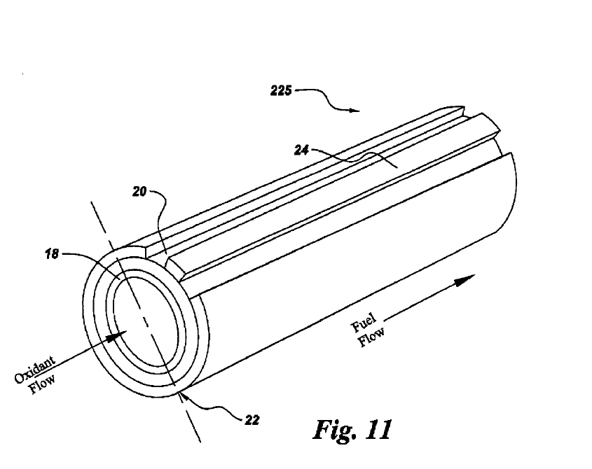

In another embodiment, fuel cell stack 220 includes a number of fuel cells 225, for example SOFC's, arranged in a tubular configuration. An exemplary fuel cell arranged in a tubular configuration is shown in FIG. 11.

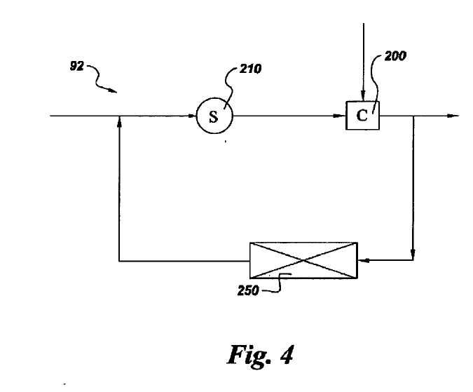

A particular embodiment of fuel cell assembly 10 is described with reference to FIGS. 3 and 4. For this embodiment, control system 92 is configured to adjust the oxidant flow from inlet 90 to direct flow channel 110 and bypass flow channel 230, in response to a feedback signal. For example, control system 92 apportions the oxidant flow from inlet 90 to bypass and direct channels 110, 230 based on factors such as the thermal load distribution across fuel cell assembly 10 at a given time. Beneficially, controlling the oxidant flow to bypass and direct channels 110, 230 enhances thermal management, including maintenance of a predetermined thermal gradient across fuel cell stack 220, thereby enhancing the performance of fuel cell stack 220.

For the particular embodiment illustrated in FIG. 4, control system 92 includes at least one flow regulator 250, a flow controller 200, and at least one control sensor 210. Flow regulator 250 is configured to regulate the oxidant flow to direct and bypass channels 230, 110. Flow controller 200 is configured to receive the feedback signal and to actuate flow regulator 250. Control sensor 210 is configured to supply the feedback signal to flow controller 200. For example, control sensor 210 measures a temperature, voltage, electrical current, or heat flux parameter. According to a particular embodiment, control sensor 210 is a temperature sensor 210. One exemplary temperature sensor 210 is an invasive temperature sensor 210, which is in intimate contact with a downstream control point 130 in fuel cell assembly 10. Invasive temperature sensors 210 are known, and examples thereof include thermocouples, thermoelectric devices, resistance temperature devices, diode thermometers, capacitance thermometers and fiber optic thermometers. Another exemplary temperature sensor 210 is a non-invasive temperature sensor, which is in remote communication with an upstream control point 128 in fuel cell assembly 50. Non-invasive temperature sensors 210 are known, and examples thereof include pyrometers, and infrared spectrometers. Exemplary upstream control points 128 and downstream control points 130 include any fluid or solid points within the thermal control volume of the fuel cell assembly 10, as illustrated in FIG. 3, and including, for example, sensor 210 being immersed in the oxidant flow or attached to or embedded within a surface.

An exemplary flow controller 200 is illustrated in FIG. 4. In one embodiment, the exemplary flow controller 200 is configured to compare the feedback signal received from control sensor 210 with a predetermined parameter value and generate a feedback signal output. For another embodiment, the flow controller 200 is configured to input the feedback signal to a predictor algorithm and compare a resulting output with a target value to generate the feedback signal output. The predetermined parameter value is selected to maintain the thermal environment of fuel cell stack 220 within a prescribed limit or range. Flow regulator 250 is actuated in response to the feedback signal output. This result in apportioning the oxidant flow from inlet 90 to bypass and direct channels 110, 230. An exemplary flow regulator 250 is a flow control valve, examples of which include globe valves, gate valves, needle valves, and butterfly valves. As is known to those skilled in the art, control systems process and compare feedback signals in a variety of ways and the present invention is not limited to any particular signal processing scheme.

As illustrated in FIG. 4, the exemplary control system 92 is configured to monitor a parameter value, such as temperature, compare the parameter value with a predetermined parameter value, and generate a feedback signal output for actuating flow regulator 250, for example flow control valve 250. These steps are repeated to maintain the operating thermal parameter value of the fuel cell assembly 10 within the prescribed limit or range as governed by the predetermined parameter value. For example, temperature sensor 210 measures a temperature value in housing 80. Flow controller 200 compares the temperature value with a predetermined temperature value. If the temperature value exceeds the predetermined value, flow controller 200 directs flow regulator 250 to decrease the portion of the oxidant flowing through bypass flow channel 110, to cool fuel cell stack 220. Alternatively, if the temperature value falls below the predetermined value, flow controller 200 directs flow regulator 250 to decrease the portion of the oxidant flowing through direct flow channel 230. By repeatedly monitoring the thermal environment of fuel cell stack 220 and adjusting the oxidant flow through bypass and direct flow channels 110, 230 in response, control system 92 improves the thermal management of fuel cell assembly 10, by compensating for fluctuations of the thermal load of fuel cell stack 220. In this manner, the exemplary control system 92 helps maintain the operating temperature of fuel cell assembly 10 within prescribed limits or ranges.

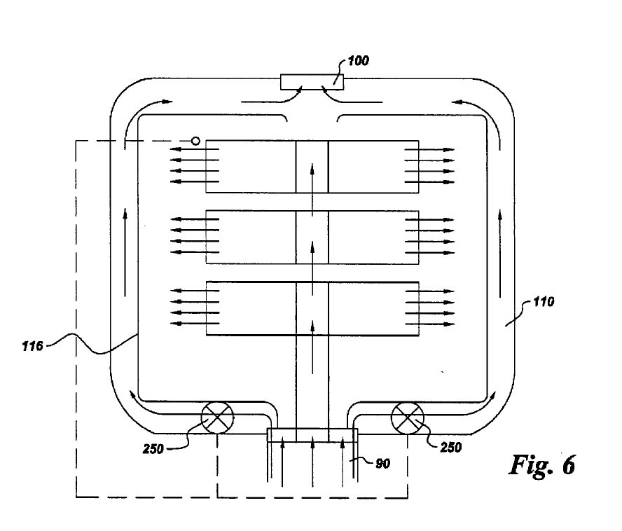

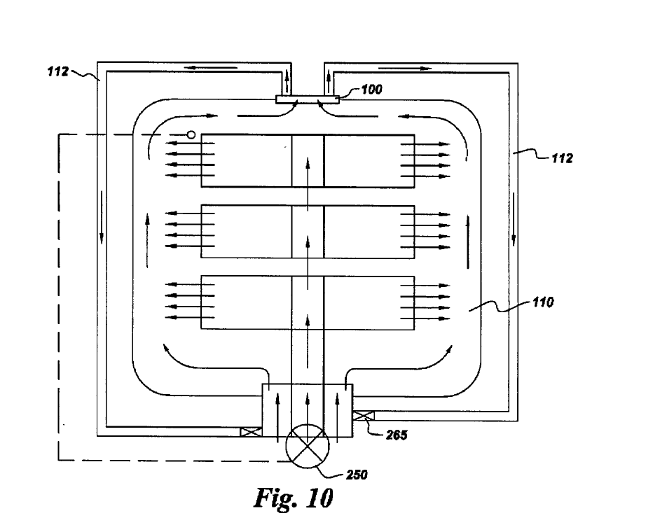

Several exemplary bypass flow channel 110 configurations are illustrated in FIGS. 3, 6, and 10. For the embodiment illustrated in FIG. 3, bypass flow channels 110 extend along an inner surface 105 of the housing 80 and are defined by fuel cell stack 220 and housing 80. For the embodiment of FIG. 6, a flow liner 116 is disposed within housing 80, and bypass flow channel 110 is disposed between flow liner 116 and housing 80 and extends along an inner surface 105 of housing 80. For the embodiment depicted in FIG. 10, bypass flow channel 110 is configured to recycle at least a portion of the oxidant flow through bypass flow channel 110 to inlet 90. More particularly, the fuel cell assembly 10 illustrated in FIG. 10 includes a re-circulating flow channel 112, which directs at least a portion of the oxidant flow through a bypass flow exit 113 to the inlet 90, to form a recycle loop. For the particular embodiment illustrated in FIG. 10, fuel cell assembly 10 further includes a non-return valve 265 to prevent backflow through re-circulating flow channel 112.

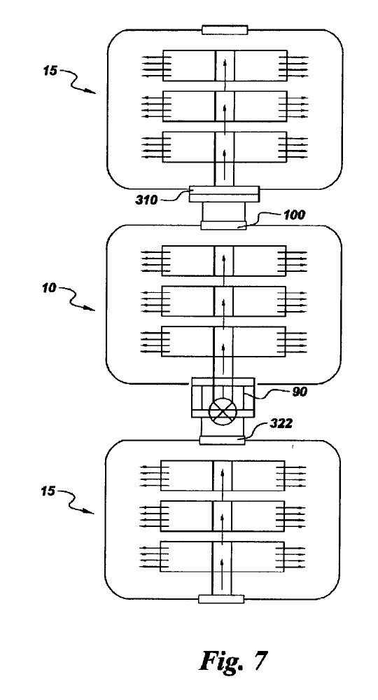

Manufacturing requirements constrain the size of both fuel cells and fuel cell stacks. Accordingly, for certain applications, it is useful to connect fuel cell assembly 10 to at least one other fuel cell assembly 15, to achieve a required power output, for example. The other fuel assembly 15 can be the same as fuel cell assembly 10 or can differ, depending on the specific application. For such applications, outlet 100 is configured to be in fluid communication with a subsequent inlet 310 of a subsequent fuel cell assembly 15. Similarly, for other applications, inlet 320 is configured to be in fluid communication with a preceding outlet 322 of a preceding fuel cell assembly 15. For compactness, both applications are shown together in FIG. 7. Beneficially, these multi-staging configurations facilitate pre and post-conditioning of flow to the fuel cell assemblies 10, 15, as well as providing more control points.

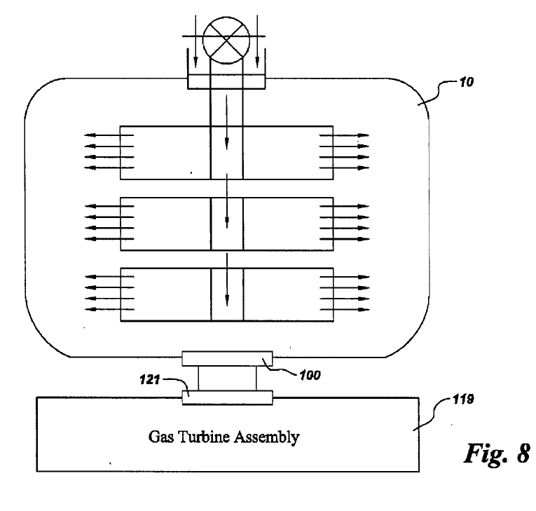

For hybrid applications, fuel cell assembly 10 is used with a turbine engine 119, for example a gas turbine 119. For these applications, the housing 80 of fuel cell assembly 10 is pressurized, for example up to about five (5) atmospheres. According to one embodiment, outlet 100 is configured to be in fluid communication with a subsequent inlet 121 of a turbine engine assembly 119, as shown in FIG. 8. Hot pressurized exhaust gas at a temperature from about 600° C. to about 800° C. from fuel cell assembly 10 exits through outlet 100 and enters turbine engine assembly 119 such as gas turbine assembly, which is configured to co-generate power . Beneficially, this hybrid application provides higher combined cycle efficiency, which in turn enhances efficiency of the overall system. In another embodiment, inlet 90 is configured to be in fluid communication with a preceding outlet 123 of a turbine engine assembly 119 such as gas turbine assembly, as indicated in FIG. 10, for power cogeneration applications.

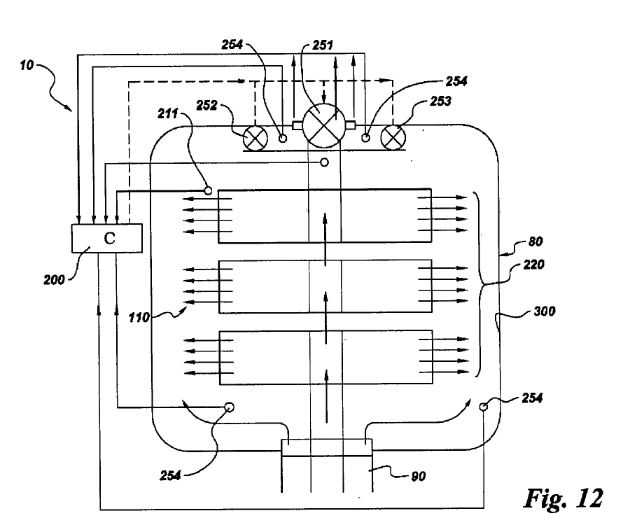

Another fuel cell assembly 10 embodiment is illustrated in FIG. 12. The fuel cell assembly 10 of FIG. 12 is similar to that described above with respect to FIG. 3. For the embodiment shown in FIG. 12, control system 92 includes at least one flow regulator 251, 252, 253 positioned upstream of the fuel cell stack 220, for example at outlet 100 of the fuel cell assembly 10, as shown for flow regulator 251. Other exemplary upstream positions for flow regulator 252, 253 include being positioned in bypass flow channel 110, as indicated in FIG. 12. According to a more particular embodiment, the flow regulators 252, 253 form a single axisymmetric flow regulator, which is indicated by the two reference numbers 252 and 253 to indicate that it is axisymmetric in nature. In other embodiments, the flow regulators indicated by reference numerals 252, 253 comprise a number of individual flow regulators located at different positions. Control system 92 further includes flow controller 200 and at least one control sensor 251, 254, which is configured to supply the feedback signal to flow controller 200. Exemplary control sensors 211, 254 are indicated in FIG. 12 and are positioned at exemplary control points within the thermal control volume of the fuel assembly 10. Control sensors 211, 254 are configured to measure a parameter, such as temperature, pressure, voltage, electrical current, or heat flux. For example, one exemplary control sensor at a control point 211 is a temperature sensor. The parameter values, for example temperature values, are supplied to flow controller 200 to generate a feedback signal output. Flow controller 200 directs flow regulators 251, 252, 253 to apportion the oxidant flowing through direct flow channel 230 and the bypass flow channel 110, depending on the feedback signal output. By repeatedly monitoring the thermal environment of fuel cell stack 220 and adjusting the oxidant flow through bypass and direct flow channels 110, 230 in response, control system 92 improves the thermal management of fuel cell assembly 10, by compensating for fluctuations of the thermal load of fuel cell stack 220. In this manner, the exemplary control system 92 helps maintain the operating temperature of the fuel cell assembly 10 within prescribed limits or ranges.

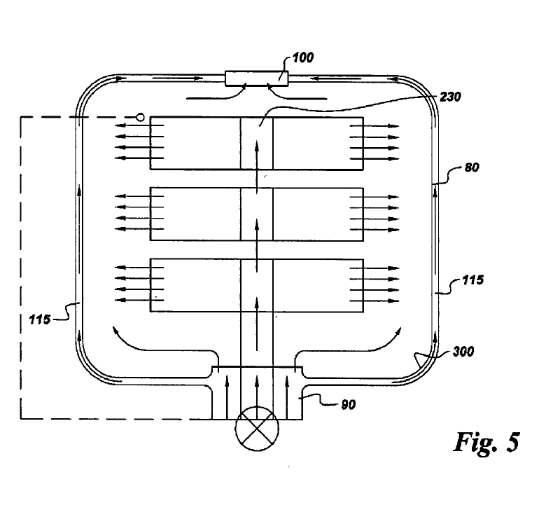

Another fuel cell assembly 10 embodiment is illustrated in FIG. 5. The fuel cell assembly 10 of FIG. 5 is similar to that described above with respect to FIG. 3 but further includes at least one bypass flow duct 115 extending along housing 80 and configured to be in fluid communication with inlet 90, as indicated in FIG. 5. Bypass flow ducts 115 provide variable bypass flow for cooling fuel cell stack 220, in response to thermal fluctuations within housing 80. For the fuel cell assembly 10 embodiment of FIG. 5, control system 92 is configured to control an oxidant flow from inlet 90 to direct flow channel 230 and bypass flow duct 115. For the particular embodiment illustrated in FIG. 5, bypass flow duct 115 is also configured to be in fluid communication with outlet 100. Exemplary bypass flow ducts 115 extend along an outer wall of housing 80, as shown in FIG. 5, or are disposed within housing 80 in the same manner as bypass flow channel 110 defined by bypass flow liner 116 in FIG. 6. Like the fuel cell assembly 10 embodiment discussed above with respect to FIG. 3, an exemplary control system 92 regulates the oxidant flow through direct flow channel 230 and bypass flow ducts 115 in response to a feedback signal, for example as described above with respect to FIG. 4.

A method embodiment of the invention is described with reference to FIGS. 3 and 4. The method for controlling a thermal environment of fuel cell stack 220 includes apportioning an oxidant flow between direct and bypass flow channels 230, 110, as indicated in FIG. 3. For the embodiment illustrated in FIG. 3, apportionment of the oxidant flow includes adjusting the oxidant flow through direct and bypass flow channels 230, 110 in response to a feedback signal output. In accordance with the particular embodiment illustrated in FIGS. 3 and 4, the adjustment includes monitoring the thermal environment of fuel cell stack 220 to generate a feedback signal and actuating flow regulator 250 in response to the feedback signal output, an exemplary flow regulator 250 being positioned in inlet 90 and being configured to alter the oxidant flow from inlet 90 to direct and bypass flow channels 230, 110. More particularly, the monitoring includes repeatedly measuring a parameter, such as temperature, voltage, current or heat flux, and comparing the measured parameter value with a predetermined parameter value. In accordance with a particular embodiment, monitoring the thermal environment of fuel cell stack 220 includes measuring a temperature value, for example within housing 80, and comparing the temperature value with a predetermined temperature value, to generate the feedback signal output. More particularly, the monitoring, and actuating steps are repeated to maintain the operating temperature value of the fuel cell assembly 10 within a predetermined temperature range. Beneficially, the method for controlling the thermal environment of fuel cell stack 220 enhances the thermal management of fuel cell assembly 10 in response to changing thermal loads, to maintain the operating temperature within prescribed limits or ranges.

Another method embodiment of the invention is described with reference to FIG. 12. For this embodiment, the adjustment of the oxidant flow through direct and bypass flow channels 230, 110 in response to a feedback signal output includes monitoring the thermal environment of fuel cell stack 220 to generate the feedback signal and actuating at least one flow regulator 251, 252, 253 positioned upstream of the fuel cell stack 220, for example at outlet 100 or within bypass channels 110, in response to the feedback signal output. According to a particular embodiment, the monitoring of the thermal environment of fuel cell stack 220 includes measuring a temperature value, for example within housing 80, and a pressure differential between the upstream flow path and the downstream flow path of the fuel cell stack 220 to generate the feedback signal output. More particularly, the monitoring and actuating steps are repeated to maintain the operating temperature value of the fuel cell assembly 10 within a predetermined temperature range.

Although only certain features of the invention have been illustrated and described herein, many modifications and changes will occur to those skilled in the art. It is, therefore, to be understood that the appended claims are intended to cover all such modifications and changes as fall within the true spirit of the invention.

1. A fuel cell assembly comprising:
a housing having an inlet and an outlet and defining at least one bypass flow channel, said bypass flow channel being configured to be in fluid communication with said inlet, said inlet and outlet being configured to provide fluid communication to and from said housing, respectively;
at least one fuel cell stack disposed within said housing and defining at least one direct flow channel, said at least one fuel cell stack comprising at least one fuel cell, and said direct flow channel being configured to be in fluid communication with said inlet and outlet; and
a control system, which is configured to control an oxidant flow from said inlet to said direct and bypass flow channels.

2. The fuel cell assembly of claim 1, wherein said bypass flow channel is further configured to be in fluid communication with said outlet.

3. The fuel cell assembly of claim 2, wherein said control system is configured to adjust the oxidant flow to said direct and bypass flow channels in response to a feedback signal.

4. The fuel cell assembly of claim 3, wherein said control system comprises:
at least one flow regulator, which is configured to regulate the oxidant flow to said direct and bypass flow channels;
a flow controller, which is configured to receive the feedback signal and to actuate said at least one flow regulator; and
at least one control sensor, which is configured to supply the feedback signal to said flow controller.

5. The fuel cell assembly of claim 4, wherein said control sensor is configured to monitor a parameter selected from the group consisting of temperature, voltage, electrical current, and heat flux.

6. The fuel cell assembly of claim 5, wherein said control sensor comprises a temperature sensor.

7. The fuel cell assembly of claim 6, wherein said control sensor comprises an invasive temperature sensor, which is in intimate contact with a downstream control point.

8. The fuel cell assembly of claim 7, wherein said control sensor comprises a non-invasive temperature sensor, which is in remote communication with an upstream control point.

9. The fuel cell assembly of claim 4, wherein said flow regulator comprises at least one control valve.

10. The fuel cell assembly of claim 2, wherein said bypass oxidant flow channel is defined by said fuel cell stack and said housing and extends along an inner surface of said housing.

11. The fuel cell assembly of claim 2, further comprising a flow liner disposed within said housing, wherein said bypass flow channel is disposed between said flow liner and said housing and extends along an inner surface of said housing.

12. The fuel cell assembly of claim 2, wherein said outlet is configured to be in fluid communication with a subsequent inlet of a subsequent fuel cell assembly.

13. The fuel cell assembly of claim 2, wherein said inlet is configured to be in fluid communication with a preceding outlet of a preceding fuel cell assembly.

14. The fuel cell assembly of claim 2, wherein said housing is configured to be pressurized, and wherein said inlet is configured to be in fluid communication with a preceding outlet of a turbine engine.

15. The fuel cell assembly of claim 2, wherein said housing is configured to be pressurized, and wherein said outlet is configured to be in fluid communication with a subsequent inlet of a turbine engine.

16. The fuel cell assembly of claim 1, wherein said bypass flow channel is configured to recycle at least a portion of the oxidant flow through said bypass flow channel to said inlet.

17. The fuel cell assembly of claim 1, wherein each of said fuel cells is selected from the group consisting of a solid oxide fuel cell, a proton exchange membrane fuel cell, a molten carbonate fuel cell, a phosphoric acid fuel cell, an alkaline fuel cell, a direct methanol fuel cell, a regenerative fuel cell, a zinc air fuel cell, and a protonic ceramic fuel cell.

18. The fuel cell assembly of claim 17, wherein said housing comprises a pressure vessel, and each of said fuel cells comprises a solid oxide fuel cell.

19. The fuel cell assembly of claim 1, wherein said at least one fuel cell stack comprises a plurality of planar fuel cells arranged in a stack.

20. The fuel cell assembly of claim 1, wherein said at least one fuel cell stack comprises a plurality of fuel cells arranged in a tubular configuration.

21. A fuel cell assembly comprising:
a housing having an inlet and an outlet, said inlet and outlet being configured to provide fluid communication to and from said housing, respectively;
at least one bypass flow duct extending along said housing and configured to be in fluid communication with said inlet;
at least one fuel cell stack disposed within said housing and defining at least one direct flow channel, said at least one fuel cell stack comprising at least one fuel cell, and said direct flow channel being configured to be in fluid communication with said inlet and outlet; and
a control system, which is configured to control an oxidant flow from said inlet to said direct flow channel and said bypass flow duct.

22. The fuel cell assembly of claim 21, wherein said bypass flow duct is further configured to be in fluid communication with said outlet.

23. The fuel cell assembly of claim 21, wherein said bypass flow duct extends along an outer wall of said housing.

24. The fuel cell assembly of claim 21, wherein said bypass flow duct is disposed within said housing.

25. The fuel cell assembly of claim 21, wherein the control system regulates the oxidant flow through said direct flow channel and said bypass flow duct in response to a feedback signal.

26. A solid oxide fuel cell assembly comprising:
a pressure vessel having an inlet and an outlet and defining at least one bypass flow channel, said bypass flow channel being configured to be in fluid communication with said inlet, said inlet and outlet being configured to provide fluid communication to and from said pressure vessel respectively;
at least one planar solid oxide fuel cell stack disposed within said pressure vessel and defining at least one direct flow channel, said at least one planar solid oxide fuel cell stack comprising at least one planar solid oxide fuel cell, and said direct flow channel being configured to be in fluid communication with said inlet and outlet; and
a control system, which is configured to adjust an oxidant flow from said inlet to said direct and bypass flow channels in response to a feedback signal.

27. The solid oxide fuel cell assembly of claim 26, wherein said at least one planar solid oxide fuel cell stack comprises a plurality of planar solid oxide fuel cells arranged in a stack.

28. The solid oxide fuel cell assembly of claim 26, wherein said control system comprises:
a flow regulator, which is configured to regulate the oxidant flow to said direct and bypass flow channels;
a flow controller, which is configured to communicate a temperature feedback signal and to actuate said at least one flow regulator, the feedback signal comprising the temperature feedback signal; and
at least one temperature sensor, which is configured to generate the temperature feedback signal from at least one control point and communicate the temperature feedback signal to said flow controller.

29. The solid oxide fuel cell assembly of claim 26, wherein said control system is further configured to repeatedly monitor the temperature feedback signals.

30. The fuel cell assembly of claim 26, wherein said inlet is configured to be in fluid communication with a preceding outlet of a turbine engine.

31. The fuel cell assembly of claim 26, wherein said outlet is configured to be in fluid communication with a subsequent inlet of a turbine engine.

32. A method for controlling a thermal environment of a fuel cell stack, the fuel cell stack comprising at least one fuel cell, being disposed within a housing and having at least one direct flow channel, the housing having an inlet and an outlet, and the inlet being in fluid communication with the direct flow channel and with a bypass flow channel, said method comprising:
apportioning an oxidant flow between the direct and bypass flow channels.

33. The method of claim 32, wherein said apportionment comprises adjusting the oxidant flow through the direct and bypass flow channels in response to a feedback signal output.

34. The method of claim 33, wherein said adjustment comprises:
monitoring the thermal environment of the fuel cell stack to generate the feedback signal output; and
actuating at least one flow regulator positioned at the inlet in response to the feedback signal output, the flow regulator being configured to alter the oxidant flow from the inlet to the direct and bypass channels.

35. The method of claim 34, wherein said monitoring comprises:
measuring a parameter selected from the group consisting of temperature, voltage, current and heat flux at a plurality of time steps to obtain a measured parameter value; and
comparing the measured parameter value with a predetermined parameter value.

36. The method of claim 34, wherein said monitoring comprises measuring a temperature value within the housing and comparing the temperature value with a predetermined temperature value to generate the feedback signal output.

37. The method of claim 36, further comprising repeating said monitoring and actuating steps to maintain the temperature value within a predetermined temperature range.

38. The method of claim 33, wherein said adjustment comprises:
monitoring the thermal environment of the fuel cell stack to generate the feedback signal output; and
actuating at least one flow regulator positioned upstream of the fuel cell stack, in response to the feedback signal output, the flow regulator being configured to apportion the oxidant flow through the direct and bypass channels.

39. The method of claim 32, further comprising recycling a portion of the oxidant flow through the bypass flow channel to the inlet.

40. A fuel cell assembly comprising:
a housing having an inlet and an outlet and defining at least one bypass flow channel, which is configured to be in fluid communication with said inlet and said outlet, said inlet and outlet being configured to provide fluid communication to and from said housing, respectively;
at least one fuel cell stack disposed within said housing and defining at least one direct flow channel, said at least one fuel cell stack comprising at least one fuel cell, and said direct flow channel being configured to be in fluid communication with said inlet and outlet; and
a control system, which is configured to control an oxidant flow through said direct and bypass flow channels.

41. The fuel cell assembly of claim 40, wherein said control system comprises:
a plurality of flow regulators positioned upstream of said fuel cell stack, each of said flow regulators being configured to regulate the oxidant flow to said direct and bypass flow channels;
a flow controller, which is configured to receive a feedback signal and to actuate each of said flow regulators; and
at least one control sensor, which is configured to supply the feedback signal to said flow controller.
